(19) United States
(12) Patent Application Publication
(10) Pub. No.: US 2008/0029941 A1
(43) Pub. Date: Feb. 7, 2008

(54) Hysteresis damping device for a vibratory body

(76) Inventor: Michael Idarecis, Baldwin, NY (US)

Correspondence Address: CHARLES E. BAXLEY, ESQ., 90 JOHN STREET, THIRD FLOOR, NEW YORK, NY, 10038, US

(21) Appl. No.: 11/653,732

(22) Filed: Jan. 15, 2007

Related U.S. Application Data
(63) Continuation-in-part of application No. 11/499,597, filed on Aug. 4, 2006, now abandoned.

(51) Int. Cl. F16M 1/00

(52) U.S. Cl. 267/136

(57) ABSTRACT

A hysteresis damping device for a vibratory body. A body has a main portion and a top portion. The top portion is one-piece with the main portion and extends coaxially upwardly therefrom. The main portion is cylindrically-shaped and the top portion is axially compressed cone-shaped so as to form a concave side wall therefor and allow the body to taper. The body is made from brass to provide reduced stiffness therefor to dissipate more energy. The main portion has a bottom end held fixed to the vibratory body so as to allow the body to cantilever from the vibratory body and allow the other end of the body to be free to vibrate. In another embodiment, the bottom of the main portion has a threaded blind bore coaxially therein and a nipple threadably engages therein and threadably extends into the vibratory body to provide length adjustment for the tapered cantilever, depending upon what the vibratory body is, to thereby adjust amount of damping and form a dynamic system. The tapered cantilever causes changes in moments of inertia along the height of the body, keeps stress constant there along, and maximizes damping properties.

### CROSS REFERENCE

The present application is a Continuation-in-part application of co-pending U.S. application Ser. No. 11/499,597 by the same inventor filed on Aug. 4, 2006.

### 1. BACKGROUND OF THE INVENTION

A. Field of the Invention

The embodiments of the present invention relate to a damping device, and more particularly, the embodiments of the present invention relate to a hysteresis damping device for a vibratory body.

B. Description of the Prior Art

(1) Vibratory Motion and Systems.¹ ¹ Vibration Analysis, Robert K. Vierck, International Textbook Company, Scranton Penn., Second Printing, September 1969, pp 1-6.

In order for a mechanical vibration to occur, a minimum of two energy-storage elements is required—a mass that stores kinetic energy, and an elastic member that stores potential energy. These can be represented as shown in FIG. 1, which is a diagrammatic representation of a vibratory system, where m and k are the mass and the elastic elements, respectively. Assuming that horizontal movement is prevented, if m is displaced vertically from its equilibrium position and released, it will exhibit an oscillatory vertical motion. This motion is repeated in equal time intervals, and hence, is said to be cyclic or periodic. If the elastic element is linear—the spring force is proportional to its deformation—then the motion curve of the mass displacement against time will be sinusoidal in form. This is called harmonic motion and is shown in FIG. 2, which is a graph of harmonic motion vibration, where x is displacement and t is time. The difference between the motions of parts a, b, and c of FIG. 2 is entirely a result of the initial conditions of displacement and velocity. The maximum displacement X is generally referred to as the displacement amplitude. The term Φ represents the phase or phase angle and ω is a constant called the circular frequency.

Certain conditions produce cyclic or periodic motion, which is not harmonic. A motion of this type is shown in FIG. 3, which is a graph of non-harmonic motion vibration. One complete movement of any repeated motion is called a cycle. The time for one cycle is termed the period. The period is designated by τ and is generally measured in seconds. The frequency is the number of cycles of motion occurring in unit time. The symbol for frequency is f, and the most common unit is cycles per second, usually indicated by cps. Note that τ is the reciprocal of f. Thus:

f=1/τ and τ=1/f

A vibration can also be of an irregular nature as that shown in FIG. 4, which is a graph of irregular motion vibration. Here, there is no repeated part to the movement, although many of the peak displacement values may occur again and again. This type of motion—for which there is no apparent pattern in the vibration record—is called a random vibration. A random vibration is produced by input forces of an irregular nature acting upon the vibratory system. These random forces occur in missiles and space vehicles as a result of aerodynamic buffeting during launching. Packaged assemblies of structural and mechanical equipment are subjected to random forces while they are being shipped or transported.

A type of motion related to vibrations is the short-time response of a system. This motion is caused by impact conditions being imposed on a vibratory system resulting in a sudden movement as that shown in FIG. 5, which is a graph of short-time response motion vibration.

A vibratory system may be subject to resistance as a result of air friction, shock absorbers, and other dissipative elements. This resistance is called damping, and an arrangement containing this is referred to as a damped system. Typical damped-motion curves are shown in FIG. 6, which is a graph of damped motion vibration. Since there is no period for that shown in part b, this form of motion is said to be nonperiodic or aperiodic.

The system may be acted on by an external force, which is often of a repeated type that tends to maintain the oscillation. It is then designated as a forced system, and the motion is called a forced vibration. If no forcing condition exists, the motion is said to be a free vibration.

Specifying the configuration of a system may require several independent coordinates. The number of coordinates needed indicates the number of degrees of freedom of the system. The system shown in FIG. 1 requires only one coordinate to define the motion, and hence, is a single-degree-of-freedom system. FIGS. 7a and b, which are diagrammatic representations of a two-degree-of-freedom system, represent two-degree-of-freedom systems, and FIG. 7c, which is a diagrammatic representation of a three-degree-of-freedom system, exhibits a three-degree-of-freedom system. Systems of more than three degrees of freedom can be readily visualized. The term multi-degree-of-freedom system is used as a general designation for systems having several degrees of freedom. Note that a continuously distributed mass-and-elastic system, such as a beam, would have an infinite number of degrees of freedom since, in effect, it is composed of an infinite number of mass-elastic elements.

For a system of several degrees of freedom, under certain conditions, the motion in each coordinate may be harmonic. This pattern of movement is called principal mode of vibration. The number of these principal modes is equal to the number of degrees of freedom for the system.

In general, vibrations produce—or may be accompanied by—conditions which are undesirable. Stresses of magnitude may result so that a machine or structure may be damaged or destroyed. Large forces may be transmitted to supports or adjacent parts. Vibratory motion may develop enough amplitude to disturb the functioning of the mechanism involved. In other cases, although no critical condition develops, vibration may simply be objectionable because of the noise produced or the shaking condition transmitted.

Thus there exists a need for a damping device for a vibratory body.

Numerous innovations for damping devices have been provided in the prior art that will be described below in chronological order to show advancement in the art and which are incorporated herein by reference thereto. Even though these innovations may be suitable for the specific individual purposes to which they address, they each differ in structure and/or operation and/or purpose from the embodiments of the present invention, in that they do not teach a hysteresis damping device for a vibratory body.

(1) U.S. Pat. No. 4,549,456 to Elmaraghy et al.

U.S. Pat. No. 4,549,456 issued to Elmaraghy et al. on Oct. 29, 1985 in class 83 and subclass 478 teaches a noise damping guard for a circular saw blade of the type mounted for axial rotation relative to a material support plane disposed transverse to the cutting axis of the blade. The guard includes a stationary lower guard section secured beneath the support plane and a pivoted upper guard section secured above the support plane. Each guard section includes a guard frame supporting an inner pair of anti-friction metal plates secured in parallel-spaced relationship to one another to receive a saw blade therebetween and define an air gap between each side of the blade and an inner face of the metal plates. A spacer plate and a backing plate are secured to an outer face of each of the metal plates to prevent the vibration of the inner anti-friction metal plate and to provide an additional noise barrier and still further to maintain the metal plates in alignment. A pivoting support arm is secured to the guard upper section for upward displacement of the guard upper section.

(2) U.S. Pat. No. 4,609,135 to Elliesen.

U.S. Pat. No. 4,609,135 issued to Elliesen on Sep. 2, 1986 in class 227 and subclass 130 teaches a sound-dampened driving apparatus for fasteners. A main valve is arranged above a working cylinder of the apparatus and movable within a cylindrical bore. When the main valve is in its lower at-rest position, the main valve separates the working cylinder from a source of compressed air and connects the cylinder to the atmosphere. When the main valve is in its upper actuating position, the working cylinder is connected to the source of compressed air and the main valve blocks the cylinder connection to the atmosphere. The space above the main valve within the cylindrical bore is capable of being alternately connected to either the atmosphere or compressed air, and includes sound dampening arranged in the space above the main valve.

(3) U.S. Pat. No. 6,260,814 to Mathews.

U.S. Pat. No. 6,260,814 issued to Mathews on Jul. 17, 2001 in class 248 and subclass 634 teaches an air compressor for an air leveling suspension system of a motor vehicle and is mounted on a vibration reducing bracket. The bracket includes a bottom panel section having a perforated metal grid embedded therein. Side walls extend to an open top. A first set of brass inserts are embedded into a plurality of tiers that are spaced between the closed bottom panel section and an open top to mount the air compressor. A second set of brass inserts receive bolts to mount the bracket to the chassis of a motor vehicle.

### (4) United States Patent Application Publication Number 2001/0036062 to Daly et al.

United States Patent Application Publication Number 2001/0036062 published to Daly et al. on Nov. 1, 2001 in class 361 and subclass 704 teaches a vehicle air intake system, including a noise cancellation assembly. A cooling member is provided at least partially within an air passageway for dissipating heat within an electronics module portion of the noise cancellation assembly. The cooling member preferably is a brass material insert that is supported at least partially within an air passageway by a housing that supports components of the noise cancellation assembly. A connecting member that thermally couples the electronics module to the cooling member also operates to secure the electronics module to the housing in one example embodiment.

It is apparent that numerous innovations for damping devices have been provided in the prior art that are adapted to be used. Furthermore, even though these innovations may be suitable for the specific individual purposes to which they address, they would not be suitable for the purposes of the embodiments of the present invention as heretofore described, namely, a hysteresis damping device for a vibratory body.

### 2. SUMMARY OF THE INVENTION

Thus, an object of the embodiments of the present invention is to provide a hysteresis damping device for a vibratory body that avoids the disadvantages of the prior art.

Briefly stated, another object of an embodiment of the present invention is to provide a hysteresis damping device for a vibratory body. A body has a main portion and a top portion. The top portion is one-piece with the main portion and extends coaxially upwardly therefrom. The main portion is cylindrically-shaped and the top portion is axially compressed cone-shaped so as to form a concave side wall therefor and allow the body to taper. The body is made from brass to provide reduced stiffness therefor to dissipate more energy. The main portion has a bottom end held fixed to the vibratory body so as to allow the body to cantilever from the vibratory body and allow the other end of the body to be free to vibrate. In another embodiment, the bottom of the main portion has a threaded blind bore coaxially therein and a nipple threadably engages therein and threadably extends into the vibratory body to provide length adjustment for the tapered cantilever, depending upon what the vibratory body is, to thereby adjust amount of damping and form a dynamic system. The tapered cantilever causes changes in moments of inertia along the height of the body, keeps stress constant there along, and maximizes damping properties.

The novel features considered characteristic of the embodiments of the present invention are set forth in the appended claims. The embodiments of the present invention themselves, however, both as to their construction and their method of operation, together with additional objects and advantages thereof, will be best understood from the following description of the specific embodiments when read and understood in connection with the accompanying drawing.

### 3. BRIEF DESCRIPTION OF THE DRAWING

The figures of the drawing are briefly described as follows:

FIG. 1 is a diagrammatic representation of a vibratory system;

FIG. 2 is a graph of harmonic motion vibration;

FIG. 3 is a graph of non-harmonic motion vibration;

FIG. 4 is a graph of irregular motion vibration;

FIG. 5 is a graph of short-time response motion vibration;

FIG. 6 is a graph of damped motion vibration;

FIG. 7a is a diagrammatic representation of a two-degree-of-freedom system;

FIG. 7b is a diagrammatic representation of a two-degree-of-freedom system;

FIG. 7c is a diagrammatic representation of a three-degree-of-freedom system;

FIG. 8 is a force-displacement curve of hysteresis damping; and

FIG. 9 is a diagrammatic side elevational view, in partial section, of the hysteresis damping device of the embodiments of the present invention on a vibratory body.

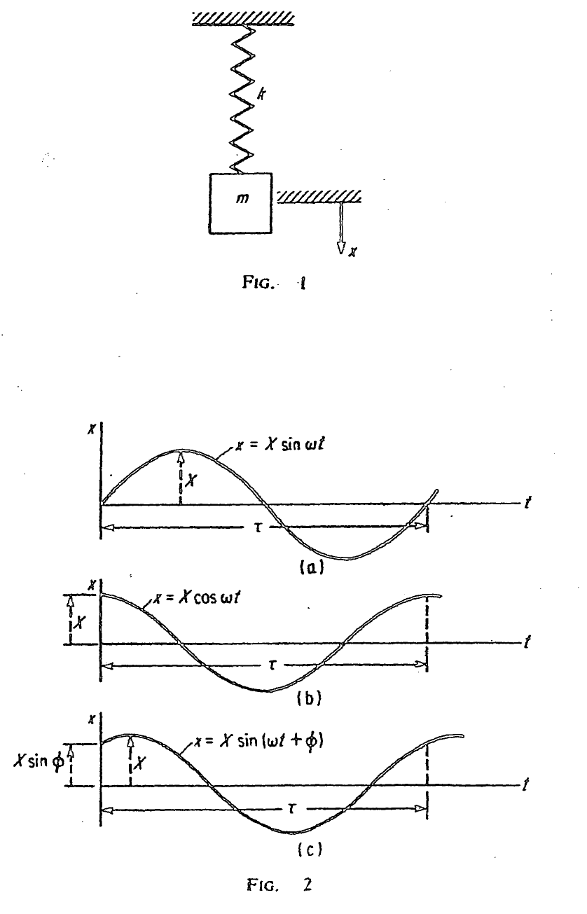

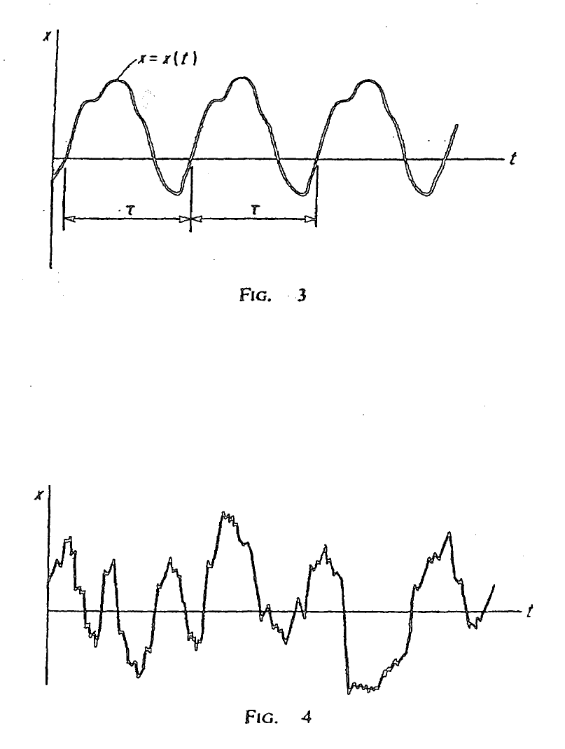

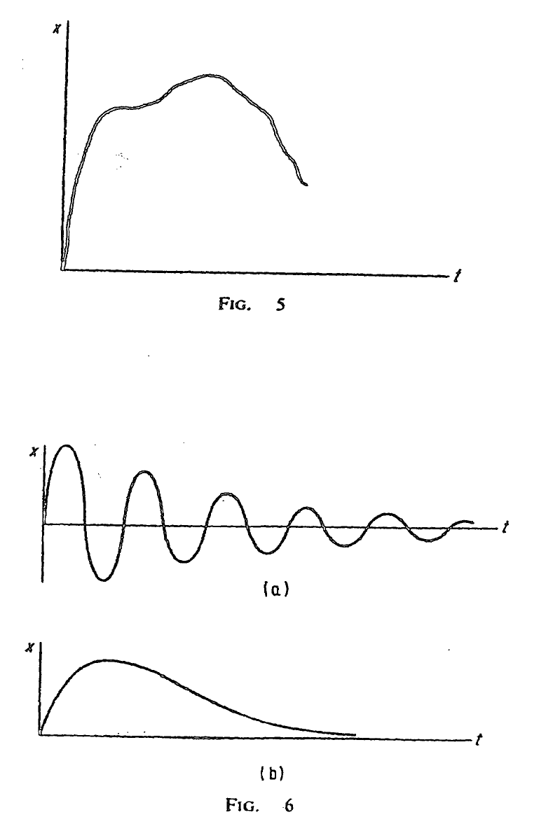

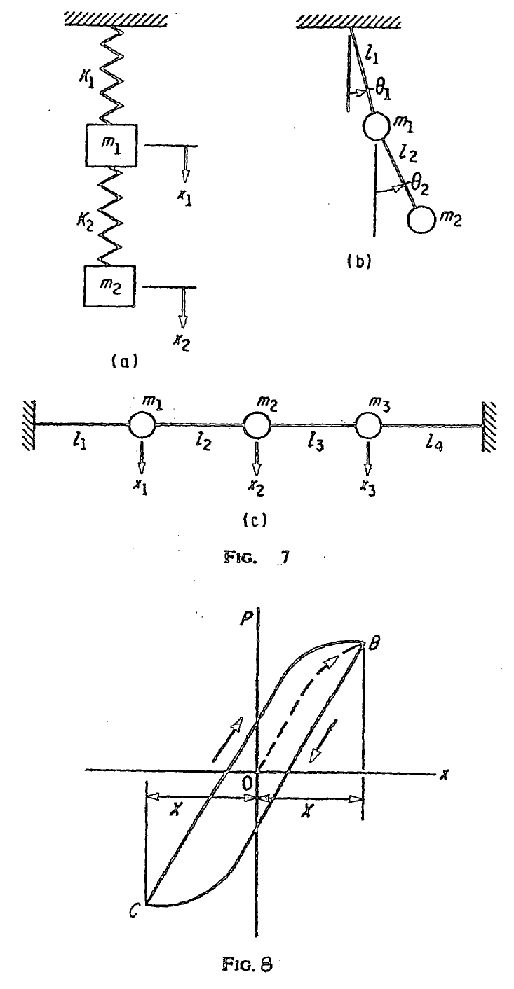

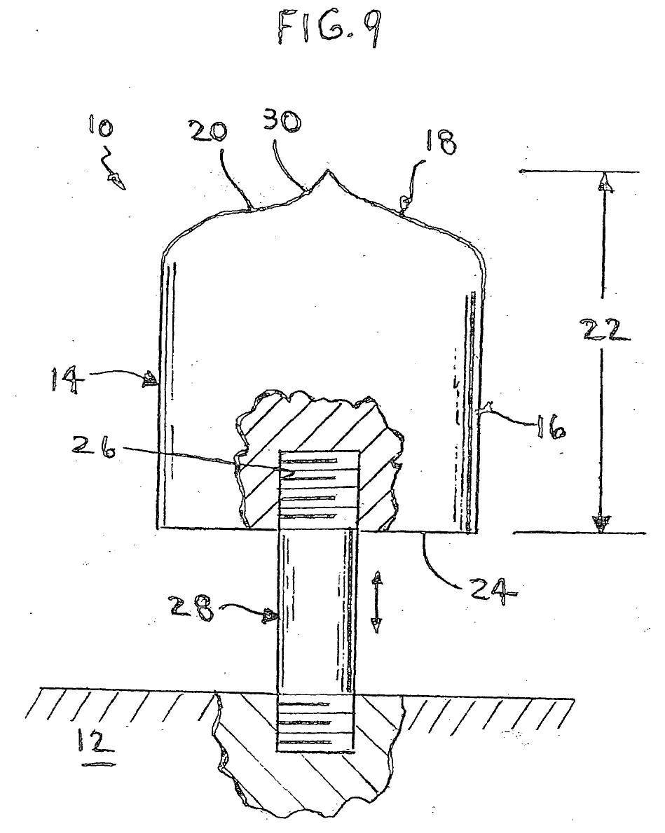

### 4. LIST OF REFERENCE NUMERALS UTILIZED IN THE DRAWING

### A. Prior Art

b hysteresis damping constant
c damping constant
f frequency
F_{d} damping force
k spring constant or modulus/elastic constant
m mass
N normal force
P force
t time
ΔU energy change
x displacement
X maximum displacement/displacement amplitude
μ coefficient of friction
τ period
Φ phase/phase angle
ω natural circular frequency
π pi

### B. Embodiments of Present Invention

10 hysteresis damping device of embodiments of present invention for vibratory body 12
12 vibratory body
14 body
16 main portion of body 14
18 top portion of body 14
20 concave side wall of top portion 18 of body 14
22 height of body 14
24 bottom end of main portion 16 of body 14
26 threaded blind bore coaxially in bottom end 24 of main portion 16 of body 14
28 nipple for threadably extending into vibratory body 12 so as to hold bottom end 24 of body 14 fixed, allow body 14 to cantilever from vibratory body 12, and allow other end 30 of body 14 to be free to vibrate

### 5. DETAILED DESCRIPTION OF THE PREFERRED EMBODIMENT

### A. Types of Damping²

### (1) Viscous Damping.

Viscous damping is fairly common, occurring, for example, when bodies move in or through fluids at low velocities. The resisting force F_{d} produced upon the body is proportional to the first power of the velocity of the motion. Thus:

F_{d}=−c\dot{x}

where the damping constant c is the constant resistance developed per unit velocity. It has the units pound second per inch, so that F_{d} has the dimension of pounds. The negative sign is used, since the damping force opposes the direction of travel. This mathematical model of damping is a good approximation in cases where bodies slide on lubricated surfaces, when bodies move in air, oil, or other fluids, and for simple shock absorbers and hydraulic dashpots, providing the speed is not too great. At high speeds, this resistance may be proportional to the square or a higher power of the velocity. ² Id. at pp 46-47.

### (2) Coulomb or Dry-Friction Damping.

Coulomb or dry-friction damping is encountered when bodies slide on dry surfaces. This type of resistance is approximately constant providing the surfaces are uniform and that the difference between the starting and moving conditions is negligible. The resisting force depends on the kind of materials and the nature of the sliding surfaces, and also upon the force normal to the surface. This is expressed as:

F_{d}=μ N

where μ is the coefficient of kinetic friction for the materials, and N is the normal force. The value of μ is determined experimentally. In the final stages of motion, this form of damping tends to predominate, since it is constant and the other types become negligible for small velocity and displacement.

### (3) Hysteresis Damping.

Hysteresis damping is also called solid or structural damping and is a result of internal friction of the material. The deformation of a member is an accumulation of the internal displacements of the material. These displacements are accompanied by frictional resistance, and the energy so absorbed is dissipated in the form of heat. This type of resistance is approximately proportional to the displacement amplitude and is independent of the frequency.

³When materials are deformed, energy is absorbed and dissipated by the material. This hysteresis effect is a result of friction between internal planes, which slip or slide as the deformations take place. This form of damping results in offsetting the parts of the force-displacement curve as shown in FIG. 8, which is a force-displacement curve of hysteresis damping, and where P is the spring force, x is the displacement, and X is the amplitude. All materials exhibit this phenomenon, with rubberlike materials showing a large loop, and metals, such as steel, displaying a very small enclosure. ³ Id. at pp 64-65.

If ΔU represents the energy loss per cycle, then:

ΔU=∫ P dx=A_{P,x}

That is, the energy loss per cycle is represented by the area within the loop. It has been found experimentally that the energy loss is independent of the frequency, but is proportional to the approximate square of the amplitude. It is also considered to be directly related to the stiffness of the member. Thus, the energy loss per cycle can be expressed as:

ΔU=π k b X²

where b is a dimensionless solid damping constant for the material. The factor k b then relates the energy loss to the size and shape of the member as well as to the material alone. Thus, the energy loss is related to the size, shape, and stiffness of the material, a fact upon which the embodiments of the present invention are based. Including the factor π was originally done so that the form would be similar to the relation for energy dissipation for maintained harmonic motion with viscous damping. The exponent of X is form 2.0 to 2.3 for certain steels, and it may be taken as 2.0 for many materials, including steel, unless extreme accuracy is required.

### B. Embodiments of the Present Invention

Referring now to FIG. 9, which a diagrammatic side elevational view, in partial section, of the hysteresis damping device of the embodiments of the present invention on a vibratory body, the hysteresis damping device of the embodiments of the present invention is shown generally at 10 for a vibratory body 12, such as, but not limited to, a motorcycle, a motor, an engine, a turbine, a cell phone, etc.

The hysteresis damping device 10 comprises a body 14. The body 14 has a main portion 16 and a top portion 18. The top portion 18 of the body 14 is one-piece with, and extends coaxially upwardly from, the main portion 16 of the body 14.

The main portion 16 of the body 14 has a diameter and is cylindrically-shaped, and the top portion 18 of the body 14 has a base diameter and is axially compressed cone-shaped so as to form a concave side wall 20 therefor and extends coaxially upwardly from the main portion 16 of the body 14 so as to allow the body 14 to taper. The base diameter of the top portion 18 of the body 14 and the diameter of the main portion 16 of the body 14 are equal.

The body 14 has a height 22 and is made from brass to provide reduced stiffness therefor to dissipate more energy.

The main portion 16 of the body 14 has a bottom end 24 with a threaded blind bore 26 coaxially therein. A nipple 28 threadably engages in the threaded through bore 26 in the bottom end 24 of the main portion 16 of the body 14 and is for threadably extending into the vibratory body 12 so as to hold the bottom end 24 of the body 14 fixed, allow the body 14 to cantilever from the vibratory body 12, and allow the other end 30 of the body 14 to be free to vibrate.

The tapered top portion 18 of the body 14 forms a tapered cantilever, which changes the moments of inertia along the height 22 of the body 14, keeps the stress constant there along, and maximizes damping properties.

The nipple 28 provides length adjustment for the tapered cantilever, depending upon what the vibratory body 12 is, to thereby adjust the amount of damping and form a dynamic system.

### C. Conclusions

It will be understood that each of the elements described above, or two or more together, may also find a useful application in other types of constructions differing from the types described above.

While the embodiments of the present invention have been illustrated and described as embodied in a hysteresis damping device for a vibratory body, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can, by applying current knowledge, readily adapt it for various applications without omitting features that, from the standpoint of prior art, fairly constitute characteristics of the generic or specific aspects of the embodiments of the present invention.

The invention claimed is:

1. A damping device for a vibratory body, comprising a body;
wherein said body is a mass of brass material; and
wherein said body communicates with, and is spaced from, the vibratory body.

2. The device of claim 1, wherein said body has a main portion;
wherein said body has a top portion; and
wherein said top portion of said body is one-piece with said main portion of said body.

3. The device of claim 2, wherein said top portion of said body extends coaxially upwardly from said main portion of said body.

4. The device of claim 2, wherein said main portion of said body is cylindrically-shaped.

5. The device of claim 4, wherein said top portion of said body is axially compressed cone-shaped so as to form a concave side wall therefor and allow said body to taper and form a tapered top portion.

6. The device of claim 2, wherein said main portion of said body has a diameter;
wherein said top portion of said body has a base diameter; and
wherein said base diameter of said top portion of said body and said diameter of said main portion of said body are equal.

7. The device of claim 2, wherein said main portion of said body has a bottom end; and
wherein said bottom end of said main portion of said body is for holding fixed to the vibratory body so as to allow said body to cantilever from the vibratory body while allowing the other end of said body to be free to vibrate.

8. The device of claim 7, wherein said bottom end of said main portion of said body has a threaded blind bore coaxially therein.

9. The device of claim 8, further comprising a nipple;
wherein said nipple threadably engages in said threaded through bore in said bottom end of said main portion of said body and is for threadably extending into the vibratory body so as to hold said bottom end of said body fixed, allow said body to cantilever from the vibratory body, and allow said other end of said body to be free to vibrate; and
wherein said nipple provides length adjustment for said cantilever, depending upon what the vibratory body is, to thereby adjust amount of damping and form a dynamic system.

10. The device of claim 5, wherein said body has a height; and
wherein said tapered top portion of said body forms a tapered cantilever, which changes moments of inertia along said height of said body, keeps stress constant there along, and maximizes damping properties.
